(19) United States
(12) Patent Application Publication
(10) Pub. No.: US 2008/0236979 A1
(43) Pub. Date: Oct. 2, 2008

(54) Power transmission apparatus

(75) Inventors: Keiji Ishikawa, Okazaki-city (JP); Yasuo Tabuchi, Toyoake-city (JP); Michiyasu Nosaka, Anjo-city (JP); Motohiko Ueda, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/076,950

(22) Filed: Mar. 25, 2008

(30) Foreign Application Priority Data
Mar. 30, 2007 (JP) 2007-091311

(51) Int. Cl. F16D 41/06

(52) U.S. Cl. 192/48.92

(57) ABSTRACT

A power transmission apparatus comprising a pulley 1 and a hub 2 is disclosed. The hub 2 includes an inner hub 21 fixed on a rotary shaft 4 and an elastic member 23 coupled over a joint length L to the outer periphery of the inner hub 21. Elastic member 23 includes a hub-side engaging portion having a series of protrusions arranged in a ring and a cylindrical portion connecting the hub-side engaging portion and the inner hub. Pulley 1 has a pulley-side engaging portion having a series of depressions fitted on the hub-side engaging portion. The engagement between hub-side engaging portion 235 and pulley-side engaging portion 14 forms a torque transmission structure of hub 2 and pulley 1. An axial length TL of a torque transmission surface TS formed by hub-side engaging portion 235 and pulley-side engaging portion 14 in contact with each other is larger than joint length L between the cylindrical portion and inner hub 21. Axial length TL, when projected in the radial direction, is partially overlapped with joint length L.

### BACKGROUND OF THE INVENTION

1. Field of the Invention

This invention relates to a power transmission apparatus for transmitting a rotational force, or in particular, to a power transmission apparatus suitably applicable to a compressor of an automotive air conditioning system.

2. Description of the Related Art

A power transmission apparatus comprising a pulley and a hub to transmit power from an engine, a motor or the like to the compressor is normally required to include a torque damper function for relaxing a abrupt variation in transmission torque, and for this reason, includes a torque transmitting elastic member formed of rubber or the like on the hub side thereof. In the prior art, this hub is composed of a torque transmitting elastic member and an inner hub and an outer hub having a comparatively high stiffness formed of a metal or the like. Torque is transmitted between the hub and the pulley by engagement between a protruded hub-side engaging portion formed on the torque transmitting elastic member and a depressed pulley-side engaging portion formed mainly on the rib portion of the pulley (Japanese Unexamined Patent Publication No. 2006-258109)

However, in the structure described in Japanese Unexamined Patent Publication No. 2006-258109, the contact pressure imposed on the protruded hub-side engaging portion is so high that the hub-side engaging portion is required to be reinforced by a stiff member such as an outer hub.

### SUMMARY OF THE INVENTION

This invention has been achieved in view of the problems of the prior art described above and an object thereof is to provide an inexpensive power transmission apparatus having the torque damper function.

As a technical means for achieving the object described above, this invention provides the power transmission apparatus described in each appended claim.

According to a first aspect of this invention, there is provided a power transmission apparatus comprising a pulley (1) mounted rotatably on a casing (6) of a rotary device having a rotary shaft (4) and a hub (2) rotated integrally with rotary shaft (4), wherein hub (2) comprises an inner hub (21) fixed on rotary shaft (4) and an elastic member (23) coupled to the outer peripheral side of inner hub (21) over a certain axial joint length (L), wherein elastic member (23) includes a hub-side engaging portion (235) making up the outer peripheral portion of the hub and having a series of annularly arranged protrusions and a cylindrical portion connecting hub-side engaging portion (235) and inner hub (21), wherein pulley (1) includes a pulley-side engaging portion (14) having a series of depressions fitted on hub-side engaging portion (235), wherein a torque transmission structure of hub (2) and pulley (1) is formed by hub-side engaging portion (235) and pulley-side engaging portion (14) and engaging, wherein an axial length (TL) of a torque transmission surface (TS) formed by hub-side engaging portion (235) and pulley-side engaging portion (14) in contact with each other is larger than joint length (L) between the cylindrical portion and inner hub (21), and wherein at least a part of axial length (TL) of torque transmission surface (TS), when projected in the radial direction, is overlapped with joint length (L).

In this configuration, the axial length of the power transmission apparatus is prevented from being increased, while at the same time securing the long axial length of the torque transmission surface (TS), and the contact pressure caused on the torque transmission surface (TS) can be reduced. As a result, a stiff member such as the outer hub conventionally used can be eliminated, and correspondingly, the power transmission apparatus can be reduced in cost.

According to a second aspect of the invention, there is provided a power transmission apparatus, wherein hub-side engaging portion (235) is extended toward pulley-side engaging portion (14) beyond the cylindrical portion and the series of the protrusions forming hub-side engaging portion (235) is composed of a plurality of diametrical protrusions formed between a plurality of first grooves (236) extending in axial direction along the outer peripheral surface of hub-side engaging portion (235) and a plurality of axial protrusions formed between a plurality of second grooves (237) extending radially on an axial end surface (232) of the part of hub-side engaging portion (235) facing pulley (1), and wherein the series of depressions making up pulley-side engaging portion (14) are configured in such a manner that the interior of pulley (1) is defined by a first rib portion (15) formed to fit the plurality of first grooves (236) and a second rib portion (16) formed to fit second grooves (237).

In this configuration, not only first grooves (236) are formed on the outer peripheral surface of elastic member (23), but also second grooves (237) are formed on one end surface thereof, and therefore the torque transmission surface (TS) can be enlarged. Further, the stiffness of pulley (1) can be increased by first and second rib portions (15, 16) formed on pulley (1). Ribs for reinforcing the pulley can also be used for power transmission with the hub.

According to a third aspect of the invention, there is provided a power transmission apparatus, wherein hub-side engaging portion (235) is connected smoothly with the cylindrical portion and first rib portion (15) and second rib portion (16) may be coupled to each other along a curve.

In this configuration, distortion which may develop between hub-side engaging portion (235) and the cylindrical portion is reduced for improved durability.

According to a fourth aspect of the invention, there is provided a power transmission apparatus, wherein a predetermined gap may be formed between the bottoms of the plurality of second grooves (237) and the top of second rib portion (16).

In this configuration, even in the case where the elastic member is deformed at the time of torque transmission, interference with second rib portion (16) can be prevented.

According to a fifth aspect of the invention, there is provided a power transmission apparatus, wherein the diametrically outer peripheral surface of the plurality of the axial protrusions may be substantially parallel to the axis of the power transmission apparatus and the diametrically inner peripheral surface of the plurality of the axial protrusions may be diagonal to the axis of the power transmission apparatus.

In this configuration, the distortion at the root of the cylindrical portion and the hub-side engaging portion can be reduced and the durability of the power transmission apparatus improved.

According to a sixth aspect of the invention, there is provided a power transmission apparatus, wherein the series of the depressions forming pulley-side engaging portion (14) may form a gap with the diametrically inner peripheral surface of the plurality of the axial protrusions.

In this configuration, the assembly efficiency of hub (2) and pulley (1) can be improved.

The reference numerals inserted in the parentheses following the names of the respective means denote an example of correspondence with the specific means described in the embodiments below.

The present invention may be more fully understood from the description of preferred embodiments of the invention, as set forth below, together with the accompanying drawings.

### BRIEF DESCRIPTION OF THE DRAWINGS

FIG. 1 is a longitudinal sectional view showing a power transmission apparatus according to an embodiment of the invention and a rotary shaft and a torque limiter related thereto.

FIG. 2 is a front view of the power transmission apparatus of FIG. 1 and the rotary shaft and the torque limiter related thereto.

FIG. 3 is a front view of the hub of the power transmission apparatus.

FIG. 4 is a longitudinal sectional view of the hub taken along line I-I in FIG. 3.

FIG. 5 is a detailed longitudinal sectional view showing a set of the hub depression and the pulley protrusions in engagement with each other.

### DESCRIPTION OF THE PREFERRED EMBODIMENTS

The preferred embodiments of the invention will be explained below with reference to the drawings.

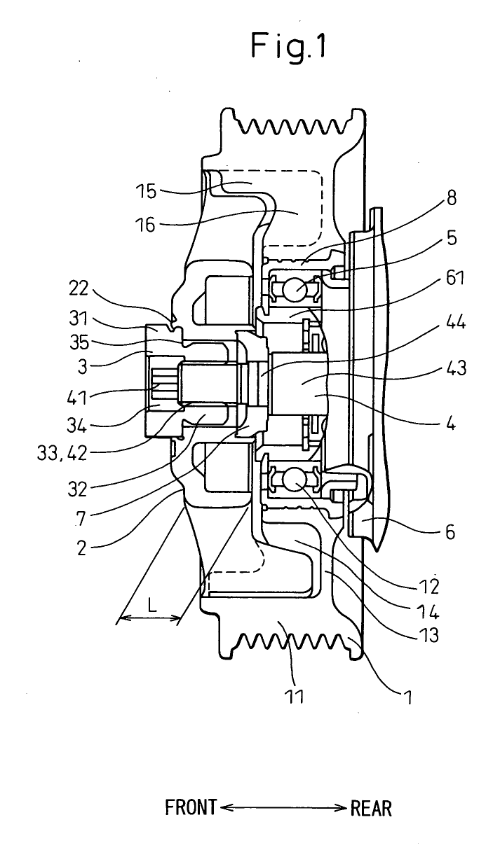

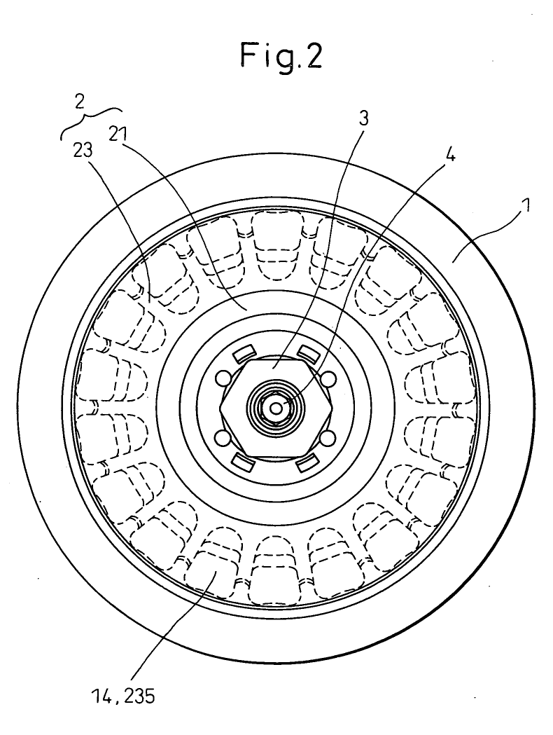

The power transmission apparatus according to this invention is suitably assembled on the compressor of an automotive air conditioning system. FIG. 1 is a longitudinal sectional view of the power transmission apparatus according to an embodiment of the invention, and FIG. 2 a front view taken from the front side in FIG. 1. The power transmission apparatus according to this embodiment includes a pulley 1 constituting a driving-side rotary member for acquiring the drive force from an engine or a motor and a hub 2 constituting a driven-side rotary member fixed on a rotary shaft 4 of the compressor, wherein power (torque) is transmitted between pulley 1 and hub 2. Pulley 1 and hub 2 are arranged on the same axis. In the case where the compressor is locked or otherwise excessive torque tends to be transmitted between pulley 1 and hub 2, a torque limiter 3 is broken to shut off the torque transmission between pulley 1 and hub 2.

As shown in FIG. 1, pulley 1 is mounted rotatably on a cylindrical portion 61 at one end of a compressor casing 6 through a bearing unit 5. Pulley 1, though preferably formed of a thermosetting synthetic resin, may be formed of a metal material such as iron. Pulley 1, having a rim portion 11 with a V-belt (not shown) wound on the outer peripheral surface thereof, is rotated by the power supplied from an external source such as an engine or a motor. Bearing unit 5, arranged between cylindrical portion 61 of casing 6 and an annular rib portion 12 of pulley 1, is prevented from moving in the axial direction by a stop ring member 8 having a substantially L-shaped section fitted in a groove formed on the outer peripheral surface of cylindrical portion 61.

The forward end of rotary shaft 4 of the compressor is projected toward the front part in FIG. 1 from casing 6, and there are arranged, in order from the forward end, a tool-like portion 41 in the form of hexagonal column, a male screw portion 42 with a male screw formed on the outer periphery thereof, a larger diameter portion 43 larger in diameter than male screw portion 42 and a middle diameter portion 44 not threaded between male screw portion 42 and larger diameter portion 43. A washer 7 having a dish-shaped section is inserted in middle-diameter portion 44, and the rear side of washer 7 is in contact with a stepped bearing surface between larger diameter portion 43 and middle diameter portion 44.

Torque limiter 3 as a safety device against excessive torque is fixed on rotary shaft 4. Torque limiter 3 is stepped and includes a larger diameter hexagonal flange portion 31 and a smaller diameter portion 32. A central hole 34 having a female screw 33 is formed through the center of torque limiter 3. Further, an annular notch 35 further smaller in diameter than smaller diameter portion 32 is arranged between flange 31 and smaller diameter portion 32. Annular notch 35 is formed in such a manner as to break under the axial force due to excessive torque which may be imposed on torque limiter 3.

Torque limiter 3 is fixed on rotary shaft 4 in such a manner that female screw portion 33 formed in central hole 34 is screwed onto male screw portion 42 of rotary shaft 4. Inner hub 21 of hub 2, described later, is arranged on the outer periphery of torque limiter 3. Inner hub 21 is fixedly fastened on rotary shaft 4 by the stepped portion of torque limiter 3 and the front end surface of washer 7 in such a manner that female screw portion 33 of torque limiter 3 is screwed onto male screw portion 42 of rotary shaft 4.

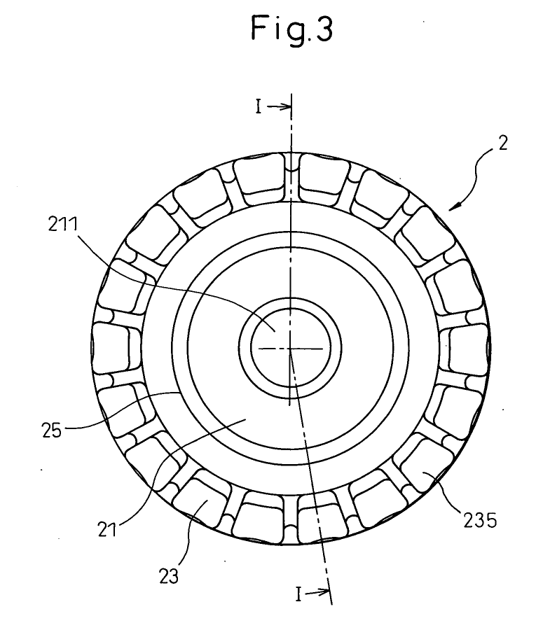

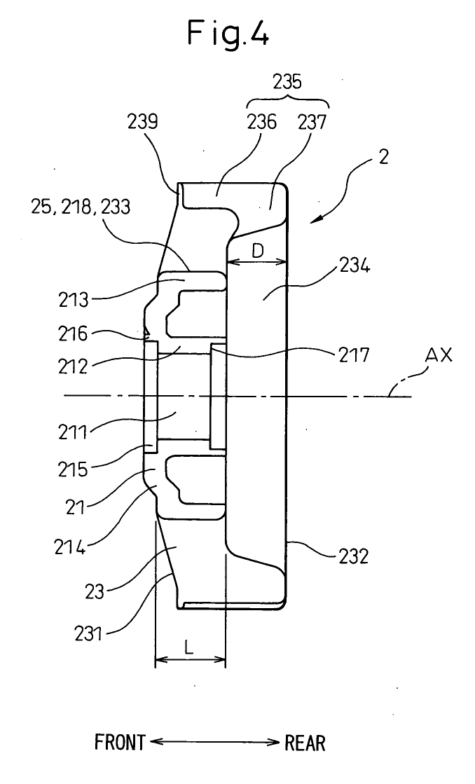

Next, hub 2 is explained with reference to the front view of FIG. 3 taken from the rear side and the longitudinal sectional view of FIG. 4 taken along line I-I in FIG. 3. Hub 2 is composed of inner hub 21 fixed on rotary shaft 4 and elastic member 23 formed of an elastic material such as rubber for torque transmission and buffering. Inner hub 21 includes an inner cylindrical portion 212 formed with a central hole 211 into which smaller diameter portion 32 of torque limiter 3 is inserted, an external outer cylindrical portion 213 and a connecting portion 214 extending in radial direction on the front side in such a manner as to couple inner cylindrical portion 212 and outer cylindrical portion 213. The front end surface of inner cylindrical portion 212 is formed with a circular depression 215 adapted to be fitted by a hexagonal flange portion 31 of torque limiter 3. In fixing hub 2 on rotary shaft 4, hexagonal flange portion 31 of torque limiter 3 is fitted in circular depression 215, after which four caulking portions 216 around circular depression 215 are plastically deformed to fix torque limiter 3 and hub 2 in axial direction. A bearing surface 217 formed on the rear end surface of inner cylindrical portion 212 is in contact with the end surface of washer 7.

Elastic member 23 includes hub-side engaging portion 235 forming the outer peripheral portion of hub 2 and having a series of protrusions arranged in a ring, and a cylindrical portion for connecting hub-side engaging portion 235 and inner hub 21 to each other and having a central coupling hole for coupling with inner hub 21. Hub-side engaging portion 235 is extended toward pulley-side engaging portion 14 beyond the cylindrical portion as described later. A front end surface 231 of the cylindrical portion is tilted about 15 degrees rearward with respect to the line perpendicular to a center axis AX, and a rear end surface 232 of hub-side engaging portion 235 is substantially perpendicular to center axis AX. Hub-side engaging portion 235 and the cylindrical portion form a substantially truncated-conical depression 234 having the depth D from the rear end surface. As a result, elastic member 23, as shown in FIG. 4, has a substantially L-shaped section as viewed from one side of center axis AX. According to this embodiment, substantially truncated-conical depression 234 provides a space for bearing unit 5 and a cylindrical portion 61 or the like to hold the bearing unit 5. Truncated-conical depression 234 may be replaced with a cylindrical depression.

According to this embodiment, the cylindrical portion of elastic member 23 and inner hub 21 are coupled to each other by bonding outer peripheral surface 218 of inner hub 21 and a peripheral wall surface 233 of the coupling hole of the cylindrical portion of elastic member 23 to each other. The axial length L of joint portion 25 formed by this coupling (hereinafter referred to as joint length L) is equal to the length L from the rear end surface to the front end surface of outer peripheral portion 213 of inner hub 21. The coupling means is not limited to bonding, but in the case where the inner hub is formed of a metal, for example, rubber or elastomer material can be fixed at the same time by injection molding the inner hub arranged in a die.

According to this embodiment, hub-side engaging portion 235 of elastic member 23 is composed of a series of 18 protrusions 235. This series of protrusions 235 are arranged in a ring around center axis AX. Protrusions 235 are composed of a plurality of diametrical protrusions formed between a plurality of first grooves 236 extending axially along the outer peripheral surface of elastic member 23 and a plurality of axial protrusions formed between a plurality of second grooves 237 extending radially along rear end surface 232 of hub-side engaging portion 235 of elastic member 23. The cross section of first grooves 236 is substantially in the shape of a U having a roundish groove bottom portion as shown in FIG. 3, and though not shown, the cross section of second grooves 237 is also substantially in the shape of a U having a roundish groove bottom portion. According to this embodiment, first groove 236 and second groove 237 have the same angular position in the circumferential direction and the same groove width while crossing each other at right angles thereby to form one continuous protrusion 235.

First grooves 236 are formed not through the whole axial width of hub-side engaging portion 235 of elastic member 23 but a filmy portion 239 remains in the neighborhood of front end surface 231. This filmy portion 239 is for preventing dust and dirt from intruding into first grooves 236. Hub-side engaging portion 235 is connected smoothly with the cylindrical portion, so that first rib portion 15 and second rib portion 16 of pulley 1 described later are connected to each other in a curve (FIG. 1). The bottom of second grooves 237 forms a predetermined gap with second rib portion 16. The diametrical peripheral surface of the axial protrusion forms a surface substantially parallel to center axis AX, while the diametrically inner peripheral surface of the axial protrusion is tilted with respect to center axis AX.

Returning to FIG. 1, pulley 1 includes a rim portion 11 wound with a belt, an axially extending annular rib portion 12 for holding bearing unit 5 and improving the stiffness of pulley 1, and a discal portion 13 extending in radial direction on the rear side to connect rim portion 11 and annular rib portion 12 to each other. Pulley 1 has a pulley-side engaging portion including a series of depressions 14 fitted on the series of protrusions 235 of hub-side engaging portion between rim portion 11 and annular rib portion 12. Depressions 14 are configured so as to be defined by an axially extending first rib portion 15 radially projected from the inner peripheral surface of rim portion 11 to fit first grooves 236 of protrusions 235 of the hub-side engaging portion and a radially extending second rib portion 16 projected toward the axial front from discal portion 13 to fit second grooves 237. According to this embodiment, first and second rib portions 15, 16 have a cross section in the shape of U having a roundish forward end. First and second rib portion 15, 16 have the same angular position in circumferential direction and the same rib width on the one hand and cross each other at right angles to form one continuous rib portion on the other hand.

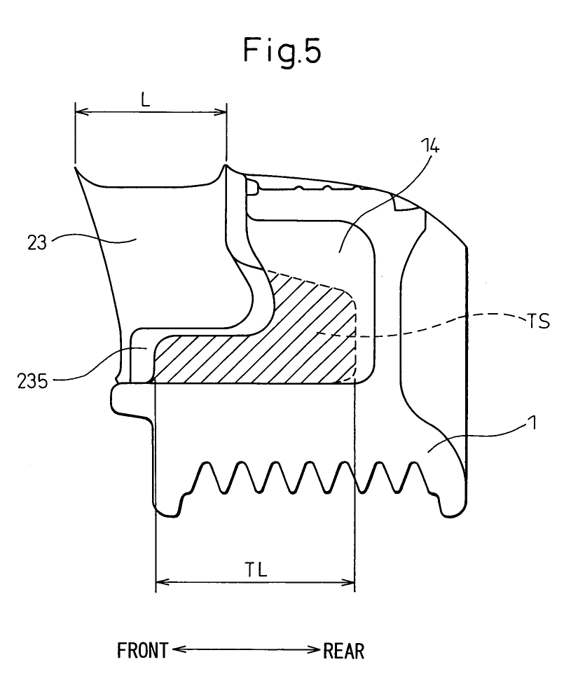

In the case where hub 2 and pulley 1 having this configuration are combined with each other, the hub-side engaging portion having 18 protrusions 235 formed on elastic member 12 come to engage the pulley-side engaging portion having 18 depressions 14 formed on pulley 1 thereby to form a torque transmission structure. FIG. 5 is a detailed longitudinal sectional view showing a set of depression 14 and protrusion 235 in engagement with each other, and the torque is transmitted through the contact between depression 14 and protrusion 235. In FIG. 5, the torque is transmitted through a hatched torque transmission surface TS. According to this invention, torque transmission surface TS has an axial length TL larger than the joint length L between elastic member 23 and inner hub 21. Axial length TL, when projected in the radial direction, is formed partially overlapped with joint length L. In other words, the front axial end position of torque transmission surface TS is located nearer to the front side than the axial rear end position of joint portion 25. The series of depressions 14 constituting the pulley-side engaging portion form a gap with the diametrically inner peripheral surface of the plurality of the axial protrusions. As a result, assembly efficiency between hub 2 and pulley 1 can be improved.

According to this embodiment, hub-side engaging portion 235 is connected smoothly with the cylindrical portion on the one hand, and first rib portion 15 and second rib portion 16 are connected to each other in a curve on the other hand. Therefore, the distortion caused between hub-side engaging portion 235 and the cylindrical portion is reduced for an improved durability.

According to this embodiment, the bottoms of the plurality of second grooves 237 form a predetermined gap with the top of second rib portion 16, and therefore even in the case where the elastic member is deformed at the time of torque transmission, interference with second rib portion 16 is prevented.

According to this embodiment, the diametrically outer peripheral surface of the plurality of the axial protrusions forms a surface substantially parallel to the axis of the power transmission apparatus, while the diametrically inner peripheral surface of the plurality of the axial protrusions is tilted with respect to the axis of the power transmission apparatus. Therefore, the distortion at the root of the cylindrical portion and the hub-side engaging portion can be reduced and the durability of the power transmission apparatus can be improved.

In the embodiment described above, protrusions 235 of elastic member 23 and depressions 14 of pulley 1 are formed of first and second grooves and first and second rib portions, respectively, having a U-shaped section. However, according to this invention, protrusions 235 and depressions 14 may have a section in any of various shapes such as a convexo-concave form of involute spline or trochoid.

According to the embodiment described above, hub 2 is fixed on rotary shaft 4 through torque limiter 3. However, according to this invention, the hub can be fixed directly on the rotary shaft, for example, in such a manner that a female screw is formed in the center hole of the inner hub and screwed on a male screw of the rotary shaft.

While the invention has been described by reference to specific embodiments chosen for purposes of illustration, it should be apparent that numerous modifications could be made thereto by those skilled in the art without departing from the basic concept and scope of the invention.

1. A power transmission apparatus comprising:
a pulley mounted rotatably on a casing of a rotary device having a rotary shaft; and
a hub rotated integrally with the rotary shaft;
wherein the hub comprises an inner hub fixed on the rotary shaft and an elastic member coupled to the outer peripheral side of the inner hub over a certain axial joint length;
wherein the elastic member includes a hub-side engaging portion making up the outer peripheral portion of the hub and having a series of protrusions arranged in a ring and a cylindrical portion for connecting the hub-side engaging portion and the inner hub,
wherein the pulley includes a pulley-side engaging portion having a series of depressions fitted on the hub-side engaging portion,
wherein a torque transmission structure is formed of the hub and the pulley by causing the hub-side engaging portion and the pulley-side engaging portion to engage each other,
wherein an axial length of a torque transmission surface formed by the hub-side engaging portion and the pulley-side engaging portion in contact with each other is larger than the joint length between the cylindrical portion and the inner hub, and
wherein at least a part of the axial length of the torque transmission surface projected in radial direction is partially overlapped with the joint length.

2. The power transmission apparatus according to claim 1,
wherein the hub-side engaging portion is extended toward the pulley-side engaging portion beyond the cylindrical portion,
wherein a series of the protrusions forming the hub-side engaging portion are composed of a plurality of diametrical protrusions formed between a plurality of first grooves extending in axial direction along the outer peripheral surface of the hub-side engaging portion and a plurality of axial protrusions formed between a plurality of second grooves extending radially on an axial end surface of the hub-side engaging portion facing the pulley, and
wherein the series of depressions making up the pulley-side engaging portion are configured in such a manner that the interior of the pulley is defined by a first rib portion formed to fit the plurality of the first grooves and a second rib portion formed to fit the second grooves.

3. The power transmission apparatus according to claim 2,
wherein the hub-side engaging portion is connected smoothly with the cylindrical portion, and the first rib portion and the second rib portion are connected to each other in a curve.

4. The power transmission apparatus according to claim 3,
wherein a predetermined gap is formed between the bottoms of the plurality of the second grooves and the top of the second rib portion.

5. The power transmission apparatus according to claim 2,
wherein the diametrically outer peripheral surface of the plurality of the axial protrusions is substantially parallel to the axis of the power transmission apparatus, and the diametrically inner peripheral surface of the plurality of the axial protrusions is tilted with respect to the axis of the power transmission apparatus.

6. The power transmission apparatus according to claim 2,
wherein the series of the depressions constituting the pully-side engaging portion form a gap with the diametrically inner peripheral surface of the plurality of the axial protrusions.
